(19) United States
(12) Patent Application Publication
(10) Pub. No.: US 2010/0131923 A1
(43) Pub. Date: May 27, 2010

(54) Method for Implementing a Medical Informatics System Based on a Computer Executable Health Narrative Coding System

(76) Inventor: Yeong Kuang Oon, Scoresby (AU)

Correspondence Address: CHRISTOPHER J. KULISH, P.C., 1531 Norwood Avenue, Boulder, CO, 80304, US

(21) Appl. No.: 12/626,837

(22) Filed: Nov. 27, 2009

(30) Foreign Application Priority Data
Nov. 27, 2008 (AU) 2008906143
May 26, 2009 (AU) 2009902407
Oct. 27, 2009 (AU) 2009905252

(51) Int. Cl. G06F 9/44; G06F 17/30; G06Q 50/00

(52) U.S. Cl. 717/108; 707/769; 707/E17.014; 705/2

(57) ABSTRACT

The present invention provides a method for implementing a medical informatics system. The method comprises the step of creating one or more named medical objects having attributes and behaviours, each object being implemented as an object in an object oriented programming paradigm, a function in a functional programming paradigm or an equivalent entity in a hybrid functional/object oriented programming paradigm, wherein the or each medical object name is derived from an algorithmic transformation of a description key assigned to a corresponding medical concept in a medical coding or classification system into an explicit health code, the named medical object having the attributes and behaviours of the corresponding medical concept, the composition of explicit health codes and medical objects derived therefrom being suitable for computer representation of medical narratives.

### FIELD OF THE INVENTION

The present invention relates to the field of medical informatics. In particular, the present invention relates to a method for implementing a computer executable health narrative coding system with single uniform vocabulary based on any given health concept coding and health classification system.

### BACKGROUND OF THE INVENTION

In this specification, where a document, act or item of knowledge is referred to or discussed, this reference or discussion is not an admission that the document, act or item of knowledge or any combination thereof was at the priority date:
(i) part of common general knowledge; or
(ii) known to be relevant to an attempt to solve any problem with which this specification is concerned.

The present invention builds on the foundation of the Docle health coding and medical classification system, which is described in U.S. Pat. Nos. 6,226,620, 7,222,066, 6,226,620 and United States Published Patent Application Nos 20060136197 and 20060178892, all of which are incorporated herein by reference.

However this invention is orthogonal to the previous inventions. It is intended to be a standalone open door solution for any current or future health concept coding and classification systems. The present invention is also upgradeable to a direct computer-executable, single uniform vocabulary health narrative coding system that enables interoperability in medical informatics.

Medical informatics aims to apply the might of computing to the human processes involved in healthcare. The field is broad, ranging from record keeping and health messaging to intelligent decision support to assist physicians in providing better care for their patients.

For effective computation in healthcare, it is desirable to represent health concepts, health narratives and programmable health narratives in a manner that is fully computational. Various health coding and classification schemes for concept representation have been proposed and implemented. Generally, these take the form of numeric classification schemes (such as ICD, SNOMED, ICPC, LOINC) or non-numeric, word-based (natural language) schemes such as the ‘docle’ coding system.

Those skilled in the art will appreciate the difference in health concept representation and health narrative representation. A health concept is equivalent to an entry in a medical dictionary, whereas a health narrative is a composition of health concepts that tell a story and comprises at least a sentence. Current approaches to computer representation of a medical narrative is health concept code centric. In particular, the common approach to medical narrative representation is based on selection of a numeric coding scheme and building a structural framework of wrapper tags (such as HL7, XML or the like) in which to embed the codes.

There are shortcomings with this approach. Principally, embedding numeric codes in an HL7 or XML-tag framework results in multiple versions of frameworks being generated on top of a plurality of health concept coding systems. There is a resultant inability to fully code a medical narrative in a consistent manner across multiple medical record architectures. The problem lies at the demarcation of the composition issue: should composition be done at the health concept code level or at the framework (i.e HL7, XML tag) level?

An alternative approach to representing medical narratives (as apposed to just representing medical concepts) is the composition of a word-based (natural language) concept coding system, such as compositional docle (or doclescript). A compositional capability in health coding enables computer representation of the meaning in a proposition in a medical narrative. An example of a medical narrative might be “If you add aspirin to warfarin you get increased bleeding risk.”.

In contrast, numeric health coding systems have limited or no compositional facilities. This may be due to the fact that most health record systems only employ codes to represent single concepts, rather than medical narratives. The usual medical concept coding process is selection from a pick list of possible descriptors mapped to the requisite health codes. However, for medical messaging and decision support, the clinician needs to code for propositions in a compositional manner. For instance, coding of complex meanings (such as “this diabetic was treated with diaformin which led to nausea”) is often required.

Coding such a meaning can be accomplished using a coded statement comprising a plurality of concatenated codes.

Those skilled in the art will realise that attempts to code medical narratives have resulted in fully differentiated and mutually exclusive coding schemes. This necessarily leads to an ‘either/or’ scenario, where institutions must choose amongst a plurality of medical coding or classification schemes and messaging frameworks, including HL7 v2, HL7 v3, doclescript or proposed Snomed-based schemes. Mutual exclusivity of the coding schemes and mutual exclusivity of the wrapper frameworks for medical narratives has led to what can be described as a global interoperable crisis (GIC), particularly in the medical messaging arena. Moreover, it is likely that ongoing initiatives in medical messaging in various territories will continue to be non-interoperable.

Currently, health authorities and clinics tend to use their own health record architecture implemented according to one or more health coding systems, as discussed above. Healthcare information is exchanged using a standard (such as the Health Language 7 protocol—HL 7) under which health codes are slotted into predefined message fields or are tagged for transmission.

The problem of non-compositional coding discussed above also impacts on the exchange of medical data. Health messages as simple as “no diabetes mellitus”; “the last hba lc was performed on 5 May 2009”; and “this person lives at 121 Borg Street” cannot be easily conveyed using current approaches.

The lack of interoperability, then, impacts on the ability to move patient medical records from one health care location to another and also on the design and implementation of medical decision support systems. The known approach to addressing this problem is the proposed use of a monolithic coding system (e.g. Snomed), a monolithic health record architecture, and a monolithic messaging system (eg. HL7).

In a sense, the problem of interoperability in health care is somewhat akin to the various computing groups developing their own virtual machines, be they ‘JVM’ (Java virtual machine), ‘CLR’ (Common Language Runtime), ‘YARV’ (Yet Another Ruby Virtual VM) or ‘Matz ruby interpreter’. Individually, these virtual machines are “silos”, that each speak their own idiosyncratic language. The analogous problem in the health domain is that different parties have separately developed their own idiosyncratic ‘virtual machines’ without giving due thought as to what language(s)' will run on them.

The numerical or non-numerical codes assigned to heath concepts in known medical classification systems also often violate variable-naming rules of current high level computer programming languages. For example, variable-naming rules do not allow the use of a series of pure numbers, such as those used in numeric health codes. Likewise, dock health coding uses characters such as “@, >, &, \ and !”, which are barred in the naming convention of computer variables, method, function or class names in modern programming languages.

The violation of variable-naming rules also implies that any computer representation of health concepts or health narratives employing known medical classification systems cannot be executed directly in a computer programming environment. In other words, a medical narrative or medical record encoded in a known medical classification systems is data rather than program code. For this reason, no thought has hitherto been given to handling health codes other than as data strings, fully segregated from the computer program(s) handling those codes.

Accordingly, it next to impossible to prove the “correctness” of a medical narrative that is a data file. However, if—in contrast—a medical narrative could be expressed as a computer program, unit and functional testing tools known to computer science (such as code compilers) could be applied to the medical narrative to test for ‘correctness’ of behaviour in a programming environment.

This relates to the fact that known health codes are passive and inert. For example, if the numeric code for diabetes mellitus is 232323. This is a symbol 232323 or a string representation of “232323”, but which ever way it is viewed it is merely a code.

### SUMMARY OF THE INVENTION

According to a first aspect of the present invention there is provided a method for implementing a medical informatics system, the method comprising the step of creating one or more named medical objects having attributes and behaviours, each object being implemented as an object in an object oriented programming paradigm, a function in a functional programming paradigm or an equivalent entity in a hybrid functional/object oriented programming paradigm, wherein the or each medical object name is derived from an algorithmic transformation of a description key assigned to a corresponding medical concept in a medical coding or classification system into an explicit health code, the named medical object having the attributes and behaviours of the corresponding medical concept, the composition of explicit health codes and medical objects derived therefrom, being suitable for computer representation of medical narratives.

The present invention takes the approach of creating ‘virtual medical objects’ from ‘explicit’ health codes that are generated from natural language descriptions of medical concepts in a medical coding or classification system. A virtual medical object is created at runtime, each time an explicit health code is encountered. It is an ‘intelligent’ coding system, in that these explicit health codes remain valid when presented verbatim in a programming environment as bare words. Moreover, by leveraging off an existing medical classification system into an object-oriented or functional programming environment, classification codes become computer programming objects with appropriate attributes and behaviours consistent with its original built in ‘belief system’.

The present invention opens the door for all health concept coding systems to be uniformly compositional, intentional and explicit in the same manner—so that medical narratives can be exchanged in the information highway.

In addition, the present invention, when implemented using the Ruby high level programming language, runs on all of the virtual machines discussed above.

Another advantage of the present invention is related to its seamless approach for health narrative coding, in that both wrapper and concept codes are of the same type. This is in contrast to the discontinuity between wrapper and concept codes observed in the prior art. The present invention can be seen as a high level health programming language that acts as a commensal with an object oriented and/or functional programming paradigm and with a given health concept coding/classification runtimes.

The explicit health codes are combined to form narrative statements. The method of composition of explicit health codes, with its formal syntax and grammar, to code for a health narrative, is the basis of the Explicit Health Programming Language (EHPL). In the computer environment, these explicit health codes are evaluated to be named medical objects.

The named medical objects representing healthcare narrative statements thus provide a proxy health coding format for the programmer that is directly computer executable, which can be used in or to effect decision support in the healthcare environment.

Typically, a medical object name is derived by first obtaining an explicit health code, which is itself obtained from a description key assigned to a corresponding medical concept in a medical coding or classification system. A naming algorithm is applied to the natural language description key of a health concept/classification code whereby the natural language description is modified to conform to an object-naming or function-naming methodology applicable to the object-oriented or functional programming paradigm.

The naming algorithm may comprise the steps of:
(a) stripping leading or trailing non-alphanumeric characters from the description key;
(b) replacing remaining non-alphanumeric characters with a delimiter character;
(c) deleting any multiple occurrences of the delimiter character; and
(d) appending or prepending a delimiter character to thereby stigmatize the medical object name from computer keywords and ubiquitous health language.

Typically, the naming algorithm comprises the further step of converting the description key to all lowercase characters or all uppercase characters after performing the stripping step.

The replacing step may comprise the step of camel casing the first character of each word of the description key.

According to some embodiments, the naming algorithm further comprises the step of permuting the words of the description key prior to the replacing step thereby enabling derivation of multiple medical object names from a single description key.

Preferably, the delimiter character is the underscore character.

Explicit health codes are distinct from natural language terminology in that they carry at least a single stigma to denote this distinction. Explicit health codes are similarly distinct from computer keywords of the object oriented/functional/hybrid programming paradigm again through the presence of at least a single stigma.

The naming algorithm to map natural language descriptions to explicit health codes may additionally or alternatively operate in accordance with the following steps:
1) replace any character that is not alphabetic or numeric or an underscore with a space character;
2) convert all remaining characters to lower case;
3) split string into words at any space character boundary to return an array of words in sequence;
4) delete selected non-substance words from array (such as ‘of’, ‘the’);
5) permute array of words;
4) for each permutation concatenate permutations of words with underscore character to produce a monolithic expression;
5) append or prepend single underscore character at the end or at the beginning of the monolithic expression.

With regard to step 5, in systems where the prepended underscore is preferred (or mandated because of naming conflicts with computer keywords), a standardization parser can be used to remove initial underscore to post-pend the underscore character.

The medical classification system may be a hierarchical medical classification system, wherein the medical objects implement a corresponding object or functional hierarchy within the class hierarchy of the programming language paradigm.

Typically, the method may include the step of creating one or more explicit health coding statements, each statement comprising one or more segments each of which is either comma- or parenthetically-delimited and comprises a pair of explicit health codes.

Explicit health code exhibit a duality, existing as symbols outside a computing environment and as medical programming objects inside a programming environment. Because of this duality, explicit health code statements can be viewed as either a series of explicit health codes divided into segments or as a series of medical objects divided into segments. Each segment is a key value pair of explicit health codes or named medical objects. Each statement may include a head segment and zero or more follower predicate segments.

Typically, the head segment includes a genre explicit health code and a subject explicit health code.

Alternatively, this can be viewed as the head segment including a genre medical object and a subject medical object.

Each of the follower segments may include a predicate segment (sometimes referred to as Key Value Cliched Predicate or KVCP) which includes a key/value pair of explicit health codes or named medical objects.

The genre medical object may be implemented as a function in a functional programming paradigm and the subject medical object and predicate medical objects as either string or symbol arguments for the function.

A health concept/classification code and its associated named medical object can computer represent a diagnosis, medication, radiology investigation, lab test, test result, medical procedure, item of patient data. To computer represent a medical statement, medical heuristic, set of medical heuristics, medical message, medical summary, fragment of medical summary, patient history or fragment of patient history, the preferred way is a composition of health concept codes or its equivalent composition of named medical objects.

A composition of named medical objects creates a medical statement object. While a patient summary object is a composition of medical statement objects.

The method according to the invention may include the step of using a messaging system for sending messages to and receiving information from the named medical objects.

Typically, responsive to receipt of a message, a named medical object acts in accordance with a stored behaviour.

Optionally, an action in accordance with a stored behaviour characteristic includes one or more of: issuing a notification of a preventative health action; issuing an alert; sending an email; printing a file; sending an sms message; telephoning a stored telephone number; opening a computer port or communication channel to receive a service query.

According to a second aspect of the present invention, there is provided a computer program implementing a medical decision support system, the medical decision support system based on data generated by performing the method according to a first aspect of the invention.

According to a third aspect of the present invention there is provided a computerised medical record system comprising a plurality of medical records, wherein each medical record is generated by the computer program according to the first aspect of the invention.

According to a fourth aspect of the present invention, there is provided a medical informatics system comprising:

(a) a data file containing a medical record coded in accordance with a medical classification system; and

(b) a computer processor for performing the method according to a first aspect of the invention,

wherein, upon performance of the method by the processor, the data file is opened and suitable named medical objects created from the data in the data file.

According to another aspect of the present invention, there is provided a system and method of improved utilization of an extant health coding system based on an explicit health programming language that is commensal and contingent on both a programming language runtime and any extant health coding runtime, having:
i) a core vocabulary terms of self-disambiguating explicit health codes which are set apart from natural health language terminology and set apart from host programming language terminology, through a process of controlled alteration of natural health language allowing for complete segregation of these explicit health codes from natural language terminology/programming runtime environment, and
ii) syntax and grammar definition and composition of said explicit health codes to form a series of explicit health programming language statements, each explicit health programming language statement having a character-delimited or parenthetically-delimited pattern of pairs, with an initial pair of genre-subject, followed by zero or more pairs of key-value cliched predicates,
wherein said series of explicit health programming language statements are used for computer representation of patient data, a patient medical record, medical heuristics or a medical message that can be parsed and run as a computer process utilizing either a functional or object-oriented model or a combination of the two programming models,
and wherein each said explicit health programming language statements comprises means for each of its core vocabulary terms to be programmatically active, and configured to receive and respond to messages from other medical objects or processes.

For a given extant health concept coding system, EHPL acts as a proxy health coding system. EHPL is not the code itself, it serves instead to point the way. In use, the given code becomes programmatically alive; it becomes active rather than inert, opening the way for compositional coding of medical narrative.

According to another aspect of the present invention there is provided a method of providing medical support, comprising:
(i) providing or accessing a natural language narrative of patient medical history;
(ii) translating this to a proxy health coding format that is directly computer executable (termed explicit health programming language (EHPL), with this EHPL runtime symbiotic with two other distinct decouple-able dynamic runtimes, namely (a) computer runtime based on any of a plurality of modern object/functional/hybrid programming environments, which confers its functionality to the EHPL, and (b) end-target health coding runtime based on any of a plurality of compositional health coding schemes (CHCS) and its associated belief system; and
iii) launching the EHPL patient narrative as both code and data as a running computer process to assist or effect medical decision support.

According to another aspect of the invention there is provided a method for implementing a medical informatics system based on a computer executable health narrative coding system with single uniform vocabulary based on any given health concept coding and health classification system comprising the step of generating a single uniform vocabulary for a given health concept coding and classification system based on an algorithmic transformation of each natural language description of each health concept code, wherein each item of this single uniform vocabulary is termed an explicit health code. Each of these explicit health codes conforms to the naming convention used in object oriented/functional/hybrid object oriented-functional programming languages. An explicit health code when presented as a bare word is evaluated by the programming environment to be a first class object in an object oriented programming paradigm or as a function in a functional programming paradigm and has attributes and behaviours of its source medical classification system.

According to another aspect of the invention there is provided a method for implementing a medical informatics system based on a computer executable health narrative coding system with single uniform vocabulary based on an explicit health code centric health concept coding and health classification system. In essence this coding system utilises a table in which an explicit health code description key is mapped to a canonical explicit health code, where the step of generating a single uniform vocabulary of explicit health codes based on an algorithmic transformation of each natural language description of each health concept code is redundant, as each description and its mapping to the canonical explicit health code of this system is already expressed in explicit health code format. Each of these explicit health code descriptions and canonical values conforms to the naming convention used in object oriented/functional/hybrid object oriented-functional programming languages.

### DETAILED DESCRIPTION OF THE INVENTION

The medical informatics system according to an embodiment of the present invention is effectively decoupled from both a computer language environment and from the health coding or medical classification system environment. The invention may be implemented alongside any medical classification system including Snomed, loinc, ICD or Docle.

A Glossary of terms used in this specification now follows.

### GLOSSARY

explicit—human readable leaving nothing implied
predicate—that part of a statement that says something about the genre-subject
segment—a component of a statement that comprises of a pair of explicit health codes
genre-subject segment—the initial segment of an explicit health language statement, comprising a genre and a subject
key value cliched predicate (KVCP)—a segment that follows an initial genre-subject segment
variable naming rules—computer variables are named using only letters and underscore for the first character, special characters are disallowed; one cannot use a pure number to be a variable name; a computer variable name does not have any embedded space character.
Explicit health programming language (EHPL)—a coding system for medical narratives that is directly computer executable
Explicit health code—a way of expressing a health concept by passing its natural language description through an algorithm that conforms to variable naming rules e.g. gout_diabetes_mellitus_transient_ischemic_attack_{—}
NLHD—natural language health dialect—a health narrative, conducive for parsing to EHPL
SHEEP—Simple Health Electronic Exchange Protocol
Commatoast—a natural language health dialect. A speciated natural language for healthcare comprising a pattern language based on an initial genre-subject and repeating key-value pairs, all comma-delimited. Known informally as a ‘toast to the humble comma’/
Parenthephilia—Explicit health programming language expressed in a functional language paradigm with a heavy dose of parentheses
Rubefy—Explicit health programming language expressed in the Ruby object oriented language paradigm
Explicit Linnean—a method of health concept coding and medical classification based on a linnean model, whereby description keys and the canonical values to which they are mapped are all expressed as explicit health codes.

Coding for Health Narratives

To code for health narratives, one or more EHPL statements are required. Standard English statements can be contrasted with EHPL statements. An English statement has a complete subject and a complete predicate. A complete subject is a noun or pronoun plus any group of words that modify the noun or pronoun that tells what or who the sentence is about. A complete predicate is a verb plus its object's, complements and adverbial modifiers, that tell what the complete subject is or does. Whereas an EHPL statement aims for clarity and simplicity.

In a nutshell, an EHPL statement is a series of one or more segments, typically comma-delimited or demarcated by a pair of matching parentheses. Each segment comprises a pair of concepts, each concept may be an explicit health code, a number, a string literal or an EHPL statement. The first segment is the genre-subject segment, in which the genre concept is paired with the subject concept. Subsequent segments of an EHPL statement are referred to as key value clichéd predicates (KVCP). An EHPL statement has a genre-subject segment and zero and more key value clichéd predicate segments. The genre basically states the background context of the statement. Examples of genre (of which currently defined are less than 20) in EHPL are “active problems”, “allergies”, “past history”, “medications”, “family history” and “administrative”. The subject is the point of the statement, much like the subject in an English statement. Hence the genre subject segment firmly describes the heart of the matter and its context.

Key Value Cliché Predicates (KVCP)

The medical profession talks in “cliches” carrying precise communicative intent, e.g. “post-op patient moribund”, “associated with diabetes”, “complicated by wound sepsis” and “leading to hives”. The pattern in medical communication is the cliché or “sound bite”.

The KVCP says something more about the genre-subject, describing it in more detail. The first component in the KVCP is the predicate key (of which currently defined are less than 100) and the second component is the value of the predicate.

An example of an EHPL statement is:
medication_amoxicillin_, for_tonsillitis_{—}

Here the genre subject is “medication amoxicillin” and the KVCP is “for_tonsillitis_”. Another useful predicate key is “context_” or abbreviated to “ctx_”, it is a ‘generic’ predicate key that means that it precedes a word that is going to describe the subject even further. For example:
Problem_fracture_femur, ctx_right_, ctx_compound_{—}

It will be apparent that the EHPL statement structure is constrained in the genre and the key of the KVCP. Explicit health codes have a free reign in populating the subject field of the genre-subject segment and the value component of the KVCP. There is no limit to the number of KVCP segments to modify the genre-subject, so as to convey the intended true meaning of the narrative statement as required. This construct of the EHPL statement means that composition of health codes is at hand for any current health coding system.

Some of the prerequisite investments required to reap composition of codes may be:
1) running all descriptions of resident health concept coding systems through the naming algorithm to produce explicit health codes; and
2) ensuring that the 20 genre keys and 100 predicate keys are coded.

As the following description makes clear, the medical informatics system of the invention, and the health coding language defined thereby will be seen to integrate well with current and future:
health coding systems;
high level computer languages; and
health messaging and health record architectures.

The system supports natural language processing into and from coded statements, which according to some health classification systems have the look and feel of natural language.

Further, users are not required to learn another health coding system.

When used in a decision support context, the cycle of medical decision support starts from transforming a medical narrative expressed in a natural language health dialect (NLHD) such as Simple Health Electronic Exchange Protocol (SHEEP), into EHPL.

EPHL is ‘dynamically bound’ to a high level computer language runtime and to a health coding runtime by the creation of named medical objects from the codes of the medical classification system as described above. Being objects in an object-oriented programming paradigm, functions in a functional programming paradigm or equivalent entities in a hybrid functionaVobject-oriented paradigm, the medical objects are not passive and inert, in contrast to the prior art.

The medical objects are then executed on the computing platform to produce a useful output.

EHPL

EHPL is a human readable, interpreted, programming language. The inventor has named the language “Explicit”, because nothing needs to be implied into the language in order to accurately encode terms in a health narrative from written form into correspondent named virtual medical objects.

EHPL comprises a core vocabulary of health codes derived from ‘natural’ health language terminology through application of a naming algorithm. The naming algorithm allows for a complete segregation of Explicit health codes from natural language terminology from which they are derived.

At the same time, Explicit health codes conform to variable-naming rules of the object-oriented or functional computer programming language in which the virtual medical objects are implemented. The naming algorithm allows for a complete segregation of Explicit health codes from the reserved key words of the programming language paradigm.

Useful features of EHPL are its ability to code for non-discrete data using number values (e.g. 80.5 kg) and literal values such as a street address (e.g. “29 Darryl Street”)

The EHPL symbols types are i) explicit health code ii) number and iii) string literals.

The syntax and grammar of an EHPL statement is based on character or parenthetical delimited segments. In the preferred embodiment for non-nested statements, the preferred character delimiter is the comma. The preferred embodiment for nested statement in EHPL uses matching pair of parentheses. In turn, each segment includes a pair of EHPL symbol types. The convention used in describing EHPL is that the first item in the segment is the ‘key’ and the second item is the ‘value’, hence a ‘key value’ pair of a segment. In most instances these symbol types are Explicit health codes.

In the context of nested statement in EHPL, an EHPL statement can be seen as an “honorary” symbol type.

The initial or header segment includes a ‘genre’ code and a ‘subject’ code—it is termed the genre-subject segment.

There follows zero or more segments that each comprises a pair of ‘key’ and ‘value’ codes/symbol types. These subsequent key/value pair can be considered, linguistically, as a ‘key value cliched predicate’ that tells us more about the subject in the initial segment.

This EHPL syntax allows for representation of both literal string information, numbers and explicit health codes.

A complete key/value clichéd predicate is generated in the event of a value with no key in the segment by consulting a lookup table. If no key is found then the default “ctx_” key is used. Otherwise, the key provided by the table is used.

For example a KVCP with the information “2008-10” is a “month-year” with a missing predicate key. The system is configured to insert the “in_” predicate key to return a corrected KVCP of “in_{—}2008-10”.

Program execution task statements are delineated from data statements through a recognition of the initial segment having the ‘task’ genre in the genre-subject segment.

Explicit codes in the data statements are parsed to end-target health code representation.

Task statements are executed.

When implemented in a functional language (such as LISP variants), the genre of the genre-subject segment and the predicate-key of the key-value-cliched-predicate are transformed into named functions, while the subject of the genre-subject pair and the value of the key-value-cliched-predicate are converted into either function names, string literals or numbers as arguments for the keys now converted to functions.

Conveniently, third party numeric health codes can be namespaced and used in the subject slot of the genre-subject segment and the value slot of the key-value-cliched-predicate-value segment. This leads to a ‘semi EHPL’ scenario, e.g. ‘(problem_icd10_{—}2323_) (for_{—} (2 year)); means the patient with code concept of icd10 2323 has had it for 2 years.

EHPL opens the way for medical messaging and electronic health records to be exchanged in a computable form and yet appear natural language like.

Naming Algorithm

The naming algorithm takes health codes from a ‘natural’ health language terminology and converts them into names for virtual medical objects.

The ‘natural’ health language terminology could be in any language (Italian, English, German or French, for example).

A preferred form of algorithm is as follows:
1. purge all instances of non-alphanumeric characters
2. convert all characters to lower case;
3. delete all instances of the ‘space’ character;
4. insert one and only one delimiter in all word boundaries; and
5. append or prepend the delimiter to the health code.

The preferred delimiter is an underscore “_” character.

In the following worked examples of the naming algorithm, the algorithm is applied to the descriptions on the left, the output of the algorithm is to the right after the =>symbol:

Transient Ischemic Attack => transient_ischemic_attack_{—}
Transient Ischemic Attack => transient_attack_ischemic_{—}
Transient Ischemic Attack => ischemic_transient_attack_{—}
Transient Ischemic Attack => ischemic_attack_transient_{—}
Transient Ischemic Attack => attack_transient_ischemic_{—}
Transient Ischemic Attack => attack_ischemic_transient_{—}
Diabetes mellitus => diabetes_mellitus_{—}
Diabetes mellitus => mellitus_{—} diabetes_{—}
Gout => gout_{—}

From these worked examples the “explicitness” of the explicit health codes will be apparent to the skilled reader.

The ubiquitous health language descriptions are the description keys to the codes in both numeric and non-numeric medical coding or classification system. These description keys collectively are the source for the generation of explicit health codes. The duality of the nature of these explicit health should be noted, namely as symbols representing a health concept, yet in a computing environment these symbols are automatically made into computer programming medical objects with attributes and methods.

The naming algorithm produces a ‘monolithic’ symbol that is a word of a ubiquitous health language. Furthermore, the sequence of letters within the symbol has no missing or misaligned characters compared to the original natural language terminology.

For example, the EHPL code for ‘heart attack’ is ‘heart_attack_’.

EHPL codes are completely segregated from ubiquitous health language through the appended or prepended delimiter. The delimiter is also an indication to a user that he is reading EHPL rather than ubiquitous health language.

As the skilled reader will appreciate, the delimiter in EHPL also does not affect human readability of these EHPL codes to describe clinical concepts. In fact, the appended or prepended delimiter, providing ‘stigmatization’ of codes, makes them instantly recognizable to be health codes by both human and computer processing.

During the stigmatization process, intermediate results are scanned for ambiguity and resolved through a process of ‘terminological disambiguation’ that generates codes that:
embody the ambiguity; and
provide a mechanism to access individual components of the ambiguity context.

Terminological descriptors with multiple meanings are expanded using an embedded OR operator amongst the plurality of associated explicit health codes linked to the terminology.

The terminological descriptors with multiple aggregative meanings are expanded using an embedded AND operator amongst the plurality of associated health codes linked to the terminology.

The stigmatization algorithm generates health codes whose embodiments do not conflict with the naming convention of variables in computer programming languages and sidestep the issue of conflict with the computer keywords of the host programming paradigm.

Virtual Medical Objects

EHPL codes, because of their naming convention, are able to serve as first class computer programming objects or computer variables/entities when bound to a high level computer language runtime.

EHPL codes are proxies for the associated underlying health coding system used. Hence EHPL codes can be seen as health-coding-agnostic ‘proxy health codes’.

EHPL codes are therefore compatible with current and future health coding systems.

In a sense, EHPL codes are ‘about-to-be-codes’, rather than codes themselves.

Explicit data types are provided for number and string literal in EHPL to handle coding for non-discrete data; the string literals are useful for representing data that does not require coding, e,g, street addresses.

Medical Narrative Representation

EHPL provides a seamless representation of medical concepts and medical narrative using a syntax and grammar to join EHPL codes together.

EHPL statements which are executable statements are distinct from ‘non-task’ data statements.

Object Creation

Named medical objects are created in EHPL by accessing the medical classification system that is stored locally or across a computer network. A hierachical classification system is preferred.

EHPL codes created in accordance with the above algorithm are strings that describe health entities or concepts such as diagnosis, medication, radiology investigation, lab test, test result, medical procedure, medical heuristic, set of heuristics pertaining to a medical concept, medical message, fragment of a medical summary, medical summary, fragment of a patient history or a patient history.

One way to create a medical programming object is to send a medical object creation message to a string object, as described above.

This triggers a lookup algorithm to generate a best fit code, or a combination of codes based on an interpretation of the string according to the predefined rules of an abstract syntactic pattern, comprising the codes of the hierarchical medical coding scheme, to represent the complete medical string entity with a lossless computer data representation.

An addressable medical programming object is generated to represent the intention of the original medical string entity.

Stored attributes and/or heuristics of the relevant medical entity are accessed from local or remote network storage.

Stored attributes and heuristics are populated into newly created medical object.

Methods specific and pertinent to the medical object based on its place in medical coding hierarchy are added to thereby make the medical object programmable.

The newly created medical object is grafted into the existing object hierarchy of the host programming language, such as in a hierarchical tree, to mirror the medical object's location in the hierarchical medical coding scheme.

The programmable medical object is used as a first class programming object, with an identical interface as the base object oriented programming language, in a computer program for medical decision support.

Similarly, an EHPL code sent as a message to a programmable medical object is similarly parsed to the abstract syntactical pattern, the part or whole abstract syntactical pattern is converted to medical programmable objects for processing to generate useful output.

More particularly, a medical object is created by invoking a vocabulary item of EHPL with its preferred stigma of a single appended underscore character, by the presentation of this explicit health code as a bare word to the host programming environment. The purposeful allowance of this invocation raises an error condition within the root object in the object hierarchy. The error condition is then ‘trapped’ in the ‘method missing subroutine’ of the root object.

A check is performed of whether the error condition is created by a symbolic representation with an appended single underscore character. In the event that there is no underscore in the symbolic representation, creation routine is exited to resume normal error handling.

In the event that there is an underscore appended at the end of the symbolic representation, then proceed to create a virtual medical object by first looking-up using the symbolic representation as the key in a table or database to obtain object attribute values held as a computer record.

Preferably attributes of the relevant record reflects the linnean heritage of the health vocabulary item and also has the phylum attribute. Based on the phylum attribute, an appropriate instance of a medical object is created with a suitable class factory identified with the specific phylum. Suitable methods and attributes consistent with the phylum and the linnean record are retrieved. This may be a therapeutic, a diagnosis, a symptom, a sign, a laboratory test, a diagnostic imaging or a heuristic.

The newly created medical object is placed into a subtree to mirror its linnean hierarchy, with the subtree being grafted into the existing object hierarchy of the host programming language.

It will be realised that this instance of medical object is extended by the search, retrieval and insertion of all relevant medical heuristics pertinent into this medical object.

The instantiated medical object is returned as a result of the original invocation of the EHPL term encountered in the programming environment.

The medical object is then free to be used to effect decision support by the invoking methods of this object. For example:

In this example the message “presentation_” is sent to the diabetes mellitus object

diabetes_mellitus_.presentation_{—}
=> [“heur:diabm,ctx:hxpx,with:feel@unwe,spef:.03,sens:.4”,
“heur:diabm,ctx:hxpx,with:thir*h,spef:.1,sens:.3”,
“heur:diabm,ctx:hxpx,with:tire,spef:.04,sens:.5”,
“heur:diabm,ctx:hxpx,with:mout@odor@keto,spef:.1,sens:.1”,
“heur:diabm,ctx:hxpx,with:urin@outp*h,spef:.3,sens:.7”,
“heur:diabm,ctx:hxpx,with:weig@loss,spef:.12,sens:.82”,
“heur:diabm,ctx:hxpx,with:skin@rash,spef:.02,sens:.07”,
“heur:diabm,ctx:hxpx,with:visi@blur,spef:.05,sens:.3”,
“heur:diabm,ctx:hxpx,with:resp@hypev,spef:.01,sens:.09”,
“heur:hype@glucc,ctx:hxpx,with:bp*h,spef:.1,sens:.1”]

In this example the message “class_” is sent to the diabetes mellitus object

diabetes_mellitus_.class_{—}
=> “endocrine@class;metaBolic@class”

In this example the message “+zopiclone_” is sent to the pregnancy object. This is akin to asking what happens when you add zopiclone to a pregnant patient. According to the invention, a warning is generated about an adverse reaction:

pregnancy_{—} + zopiclone_{—}
=> [“heur@drug:zopi,ctx:caution,with:preg,to:drug@preg@risk@c”,
“heur@drug:zopi,ctx:caution,with:preg,to:drugr”]

Natural Language Health Dialect Source Files

It will be apparent to the skilled user that a text stream of a natural language health dialect can be easily parsed to EHPL. In particular, any natural language health dialect that is appropriately comma-delimited into segmented natural language text, can be retrieved from directly inputted text from an input pane, from a file read from persistent storage, or from a file re-assembled pro re nata from a computation process is appropriate grist for transformation into EHPL.

The source file is parsed of said comma delimited text to EHPL and may be further parsed to human readable compositional docle health codes.

The parsing process separates the text into ‘need-to-parse’ and ‘no-need-to-parse’ string literal items. The presence of the predicate key “is_” or a predicate key ending with “is_” signals the ‘no-need-to-parse’ event, resulting in the predicate value being converted to a string literal using a pair of quote characters.

A patient medical summary that is comprised of EHPL statements can be executed to effect an automaton which itself is a virtual medical object that comprises medical data statements objects and executive medical programming statement objects with decision support actions.

Automatons also invoking self analysis of their own attributes to effect notifications of preventive health actions, alerts, email actions, computer printouts, computer messages, sms, automated phone calls that opens up computer ports or communication channels to service queries.

Any self modification by an automaton is saved to the source patient health record in speciated natural language format.

The automaton may be invoked by launching the source file from an email client, web browser, web service or mobile phone client, or as a background process in an iterative/recursive fashion, locally or distributed in a network.

An example conversion of a patient file from Natural Language Health Dialect—NLHD (commatoast) comma-delimited text to EHPL and its conversion to parenthephilia and rubefy is as follows:

Input file joebloggs.shp
Administration
surname: Bloggs
firstname: Joe
street: 29 Darryl st
suburb: Scoresby
state: Victoria
country: Australia
phone home: 03 97638935
phone work: 03 97638411
mobile: 041000000
email: docle@bigpond.com
medicare: 12345678
date of birth: 12-3-1953
place of birth: Geelong, Victoria
Allergies
amoxycillin, to rash
Problems
hypertension, 1977
t2dm
gout
high PSA, 2007
Medications
micardis plus, 80/12.5, 1, daily (initially telm@chlorthiaz, dose:80 mg/12.5 mg, qty:1, freq:117)
gliclazide 40 mg od
zyloprim 300 mg od
Past history
fracture radius, in 2004
Family history
carcinoma bowel, mother
Tasks planned
recall, psa, in march 2009, by email
Tasks done
email, psa, on 2007-5-12

The above is parsed to EHPL:

administration_{—} surname_{—} , is_{—} Bloggs
administration_{—} firstname_{—} , is_{—} Joe
administration_{—} street_, is_{—} 29 Darryl st
administration_{—} suburb_, is_{—} Scoresby
administration_{—} state_, is_{—} Victoria
administration_{—} country_, is_{—} Australia
administration_{—} phone_home_, is_{—} 03 97638935
administration_{—} phone_work_, is_{—} 03 97638411
administration_{—} mobile_, is_{—} 041000000
administration_{—} email_, is_{—} docle@bigpond.com
administration_{—} medicare_, is_{—} 12345678
administration_{—} date_of_birth_, is_{—} 12-3-1953
administration_{—} place_of_birth_, is_{—} Geelong, Victoria
allergy_{—} amoxycillin_, to_{—} rash_{—}
problem_{—} hypertension_, in_{—} 1977
problem_{—} t2dm_{—}
problem_{—} gout_{—}
problem high_psa_{—} , in_{—} 2007
medication_{—} micardis_plus_, unit_dose_{—} 80/12.5,
how_many_{—} 1, freq_{—} 1/7
medication_{—} gliclazide_, unit_dose_{—} 40mg , freq_{—} 1/7
medication_{—} zyloprim_, unit_dose_{—} 300mg , freq_{—} 1/7
past_history_{—} fracture_radius, in_{—} 2004
family_history_{—} carcinoma_bowel_{—} , ctx_{—} mother_{—}
tasks_{—} recall_, ctx_{—} psa_{—} , in_{—} 2009-3, by_{—} email_{—}

The same file can be parsed to Parenthephilia with explicit codes and string literals

‘((administration_{—} surname_{—} ) (is_{—} “Bloggs”))
‘((administration_{—} firstname_{—} ) ( is_{—} “Joe” ))
‘((administration_{—} street_) ( is_{—} “29 Darryl st”))
‘((administration_{—} suburb_) ( is_{—} “Scoresby”))
‘((administration_{—} state_) ( is_{—} “Victoria”))
‘((administration_{—} country_)( is_{—} “Australia”))
‘((administration_{—} phone_home_) ( is_{—} “03 97638935”))
‘((administration_{—} phone_work_)( is_{—} “03 97638411”))
‘((administration_{—} mobile_)( is_{—} “041000000”))
‘((administration_{—} email_)( is_{—} “docle@bigpond.com”))
‘((administration_{—} medicare_) ( is_{—} “12345678”))
‘((administration_{—} date_of_birth_)( is_{—} “12-3-1953”))
‘((administration_{—} place_of_birth_)( is_{—} “Geelong, Victoria”))
‘((allergy_{—} amoxycillin_)( to_{—} rash_))
‘((problem_{—} hypertension_)( in_{—} “1977”))
‘((problem_{—} t2dm_{—} ))
‘((problem_{—} gout_{—} ))
‘((problem high_psa_{—} )( in_{—} “2007”))
‘((medication_{—} micardis_plus_)( unit_{—} dose_{—} “80/12.5”)
( how_many_{—} “1”) ( freq_{—} “1/7” )
‘((medication_{—} gliclazide_) ( unit_dose_{—} “40mg”) ( freq_{—} “1/7”)
‘((medication_{—} zyloprim_)( unit_dose_{—} “300mg”) ( freq_{—} “1/7”)
‘((past_history_{—} fracture_radius) ( in_{—} “2004”)
‘((family_history_{—} carcinoma_bowel_{—} ) ( ctx_mother_{—} )
((tasks_{—} recall_) (ctx_{—} psa_{—} ) (in_{—} “2009-3”) ( by_{—} email_))

The same file parsed into docle compositional health code is as follows:

admn:surn,is:Bloggs
admn:firsn,is:Joe
admn:stre,is:29_Darryl_st
admn:subu,is:Scoreby
admn:state,is:Victoria
admn:country,is:Victoria
admn:phon@home,is:03_97638935
admn:phon@work,is:03_97648411
admn:phon@mobile,is:0410000001
admn:emai,is:docle@bigpond.com
admn:medic,is:12345678
admn:birthday,is:1953-3-12
admn:birtp,is:Geelong,Victoria
allg:amox,to:skin@rash
ev:hypet,in:1977
ev:diabm@niddm
ev:gout
ev:s@psa%ix&find%abno@high
rx:chloroth@hydr&telm,unit@dose:80mg/12.5mg,how@many:1,freq:1/7
rx:glic.unit@dose:30mg,how@many:1,freq:1/7
rx:allo,unit@dose:300mg,how@many:1,freq:1/7
phx:frac.radi,in:2004
fh:carc.bowe@larg,ctx:mother
task:reca,in:2009-3,by:emai

Docle compositional health code can be expanded to parenthephilia. The key aspect of this transformation is the conversion of the genre of the genre-subject segment into a function.

Likewise there is a conversion of the predicate-key of the key-value-cliched-predicate into a function.

The value aspect of both the genre-subject and the key-value-cliched-predicate pairs are converted to either symbols or strings. Any statements that do not have the task genre are treated as patient data and are quoted with the ‘ symbol.

‘((admn “surn”) (is “Bloggs”))
‘((admn “firsn”) (is “Joe”))
‘((admn “stre”) (is “29_Darryl_st”))
‘((admn “subu”) (is “Scoresby”))
‘((admn “state”) (is “Victoria”))
‘((admn “country”) (is “Australia”))
‘((admn “phon@home”) (is “03_97638935”))
‘((admn “phon@work”) (is “03_97648411”))
‘((admn “phon@mobile”) (is “0410000001”))
‘((admn “emai”) (is “docle@bigpond.com”))
‘((admn “medic”) (is “12345678”))
‘((admn “birthday”) (is “1953-3-12”))
‘((admn “birtp”) (is “Geelong,Victoria”))
‘((allg “amox”) (to “skin@rash”))
‘((ev “hypet”) (in “1997”))
‘((ev “diabm@niddm”))
‘((ev “gout”))
‘((ev “s@psa%ix&find%abno@high”))
‘((rx “chloroth@hydr&telm”) (unit@dose “80mg/12.5mg”)
(how@many “1”) (freq “1/7”))
‘((rx “glic”) (unit@dose “30mg”) (how@many “1”) (freq “1/7”))
‘((rx “allo”) (unit@dose “300mg”) (how@many “1”) (freq “1/7”))
‘((phx “frac.radi”) (in “2004”)
‘((fh “carc.bowe@larg”) (ctx “mother”)
‘((task “reca”) (ctx “paps”) (in “2009-3”) (by “emai”))

Docle compositional health codes may also be rubefied (i.e expanded into Ruby). Ruby has great flexibility in transitioning from string to symbol and back. Hence it is possible to run a string as code by converting it to symbols and then evaluating it. The key aspect of this transformation is the conversion of the genre of the genre-subject segment into an object. The subject is sent as a string value to the genre object, which will then handle it appropriately. The keys of the key-value-cliched-predicates are likewise defined as objects. The message sends are the values (expressed as strings) that are sent to these predicate key objects.

The demarcation between patient data and code is obtained by representing patient data as strings. The programmatic code is presented as symbols, seen below as expressions that start with the colon ‘:’ character.

“admn.‘surn’.is(‘Bloggs’)”
“admn.‘firstn’.is(‘Joe’)”
“admn.‘stre’.is(‘29_Darryl_st’)”
“admn.‘subu’.is(‘Scoresby’)”
“admn.‘state’.is(‘Victoria’)”
“admn.‘country’.is(‘Australia’)”
“admn.‘phon@home’.is(‘03_97638935’)”
“admn.‘phon@work’.is(‘03_97648411’)”
“admn.‘phon@mobile’.is(‘0410000001’)”
“admn.‘emai’.is(‘docle@bigpond.com’)”
“admn.‘medic’.is(‘12345678’)”
“admn.‘birthday’.is(‘1953-3-12’)”
“admn.‘birtp’.is(‘Geelong,Victoria’)”
“allg.‘amox’.to(‘skin@rash’)”
“ev.‘hypet’.in(‘1997’)”
“ev.‘diabm@niddm’”
“ev.‘gout’”
“ev.‘s@psa%ix&find%abno@high’”
“rx.‘chloroth@hydr&telm’.unit@dose(‘80mg/
12.5mg’).how@many(‘1’).freq(‘1/7’)”
“rx.‘glic’.unit@dose(‘30mg’).how@many(‘1’).freq(‘1/7’)”
“rx.‘allo’.unit@dose(‘300mg’).how@many(‘1’).freq(‘1/7’)”
“phx.‘frac.radi’.in(‘2004’)”
“fh.‘carc.bowe@larg’.ctx(‘mother’)”
:“task.‘reca’.ctx(‘paps’).in(‘2009-3’ ).by(‘emai’)”

Explicit Linnean Model of Health Concept Coding/Classification

It is possible to rework the docle linnean medical coding and classification system using explicit health code terminology, In this explicit Linnean system the canonical explicit key is the reference point. An example of an Explicit Linnean coding system is that of fractures involving the neck or femur. The keys are of the type Explicit Health Code (vide supra). They are either description explicit keys or its canonical explicit key

| kingdom: | object_medica_{—} |
|---|---|
| phyllum: clinical_domain_{—} | |
| class: | musculoskeletal_{—} |
| order: | femur_{—} |
| family: | disorder_bone_metabolism_{—} |
| genus: | fracture_femur_\hat{ } |
| species: | fracture_femur_neck_{—} |

docle key is: frac.femu@neck
description keys (aliases ) are:
fracture_femur_neck_{—} fracture_neck_femur_{—}
femur_neck_fracture_{—} femur_fracture_neck_{—}
neck_fracture_femur_{—} neck_femur_fracture_{—}
fractured_neck_of_femur_{—}
femoral_neck_fracture_{—}
fracture_hip_nof_{—}
snomed explicit key : snct_123423_{—}
icd explicit key : icd10_323232_{—}
canonical explicit key: fracture_femur_neck_{—}

“No code” Errors

Errors in parsing NLHD or EHPL input leads to generation of the “does not understand” or “no_code_” error, a clear parsing error message with the prepending of “does not understand” or “no_code_” to the input, to alert the user that their instructions are meaningless to the computer.

Compositional Codes

Explicit health codes can be terminal codes using the explicit linnean coding or classification system. An alternative mode is to use the docle compositional code system i.e. the grammar, syntax and semantics associated with the structure and method of stringing these health codes together to form compositional codes to represent the meaning in a sentence or proposition using the genre subject and a series of key value ‘cliched predicates’.

The invention contemplates the method of to-and-fro conversion between natural language text and compositional explicit health codes. Further, the invention embraces decomposition of EHPL statement to segments comprising pairs of EHPL terminological codes.

Medical Messaging

Explicit health codes play a useful role in medical messaging. A medical message comprising of only explicit health codes or as explicit health codes embedded in a sea of natural language are easily retrieved and processed.

These are the candidates of executable compositional health coding system that can support EHPL:
1) compositional docles
2) parenthephilia (being implementation in a functional programming paradigm);
3) rubefy (being implementation in an object-oriented programming paradigm).

In theory, any natural language health dialect can be directly translated to a capable executable compositional health coding system (ECHCS). However, a loss of portability and flexibility for some health dialects can be observed. Moreover, fixation on a particular natural language health dialect or ECHCS could potentially lead to loss of agility in software development.

Representation in compositional EHPL/Linnean Explicit/docle health codes is preferred because of the ability to achieve lossless data capture of medical information.

The flow of medical narrative translation/execution is:

NLHD—natural language health dialect—>EHPL—explicit health programming language—>ECHCS—executable compositional health coding scheme—>evaluation—>execution

Explicit health coding system runs on top of past and future health coding systems. It is well adapted for concept representation, concept disambiguation, concept membership expansion and composition for representation of propositions. It also sits happily in a programming environment. The attached Appendix provides further information regarding the explicit health programming language, by way of a Kleene star specification of EHPL.

It will be apparent to those skilled in the art that the various EBNF/Kleene star notations of the various modes/linguistic levels of coding of health narrative statement enable easy parsing from one form to another. This assists in obviating the ‘a bridge too far’ problem when parsing natural text to code.

From the above examples, it will be realised that users may retain their choice of health concept/classification coding. An algorithmic transform of the natural language description keys of his chosen health concept/classification coding system leads to a lookup table of explicit health codes mapped to his original concept codes. In return the user is rewarded with an open door to the composition of explicit health codes to represent medical narratives that are directly computer executable and programmable. Each explicit health code when presented in the computing environment is able to be initialized to be a programmable medical object.

The word ‘comprising’ and forms of the word ‘comprising’ as used in this description and in the claims do not limit the invention claimed to exclude any variants or additions. Modifications and improvements to the invention will be readily apparent to those skilled in the art. Such modifications and improvements are intended to be within the scope of this invention.

### APPENDIX

### The Kleene Star Specification of the Explicit Health Programming Language (EHPL)

EHPL is a health programming language comprised of explicit health codes, string literals, numeric data, plus a syntax and grammar.

Explicit health codes are ubiquitous health language that are made lower case and stigmatised with one trailing underscore character.

An EHPL sentence is assembled by building up pairs of meanings. The EHPL sentence is segmented by using either the comma delimiter or by the use of paired parentheses.

Each segment represents a pair. The first pairing is defined as the genre-subject segment. it has a genre key with a subject. The genre key may be one, two or three words expressed as an explicit health code. For example:
1) problems_{—}
2) past_history_{—}
3) reasonfor_encounter_.

The genre-subject segment is mandatory, to be followed by subsequent zero or more segments, these are defined as key-value-cliched-predicate (KVCP).

Each KVCP tells a more defined story about the genre-subject segment. Each key-value-cliched-predicate pairing comprises:
1) a predicate key expressed in explicit health code
2) a predicate value which may be a medical concept expressed in explicit health code, a string literal or a numeric value used in clinical medicine.
3) a predicate value may be an EHPL statement using nested parentheses.

With the Kleene star notation, (an alternative notation to EBNF), 0 indicates a choice of nothing at all, while a comma indicates a choice of several or more alternatives, while a * at the end of a name symbol means zero or more repetitions of the underlying name. A + at the end of a name symbol means one or more repetitions of the underlying name.

Using the Kleene Star Notation to Define EHPL

genre_key=“administration_”, “adverse_drug_reactions_”, “allergy_” “diagnosis_”, “assessment_”, “evaluation_” “examination_”, “objective_”, “family_history_”, “goal_”, “heuristic diagnosis_”, “heuristic_drug_”, “heuristic presentation_”, “heuristic_procedure_”, “heuristic_examination_”, “heuristic_history_”, “heuristic_investigation_”, “history_”, “subjective_” “investigation_”, “immunization_”, “keep_in_view_”, “management_”, “medication_”, “outcome_”, “past_history_”, “physical_examination_”, “presentation_”, “plan_”, “problem_”, “progress_”, “reason_for_encounter_”, “risk_from_”, “social_history_”, “task”, “treatment_”, “warning_”

predicate_key=“about_”, “above_”, “across_”, “after_”, “against_”, “ahead_of”, “along_”, “although_”, “among_”, “and_”, “around_”, “as_”, “ask_”, “associated_”, “at_”, “authority_”, “adverse_drug_reaction_”, “arising_from_”, “as_”, “associated_with_”, “association_”, “because_”, “behind_”, “below_”, “before_”, “beside_”, “between_”, “but_”, “by_”, “being_”, “compared_to_”, “complications_”, “coda_”, “consider_”, “context_” “check_”, “consequence_”, “consider_”, “context_”, “contraindication_”, “ctx_”, “date_”, “event_date_”, “during_”, “do_not_use_in_”, “dose_”, “down_”, “do not use in the event”, “due_to_”, “except_”, “extra_”, “fact_”, “from_”, “find_”, “finding_”, “finding_of”, “for_”, “formulation_”, “for_specified_reason_of”, “frequency_”, “future_treatment_”, “goal_” “how_”, “how_many_”, “if_”, “immunization_”, “in_”, “into_”, “before_”, “indication_”, “instead_of_”, “interact_”, “interaction_”, “interact_with_”, “in_case_of_”, “is_”, “like_”, “leading_to_”, “mode_action_”, “mode_of_action_”, “more_”, “near_”, “next_to_”, “no_”, “not_”, “note_”, “of_”, “on_”, “onto_”, “on_this_date_”, “outcome_”, “original_”, “over_”, “pack_”, “plan_”, “plus_”, “pregnancy_rating_”, “prior_”, “quantity_”, “range_”, “rank_”, “ranking_”, “relative_risk_reduction_”, “relative_risk_increase_”, “repeat_”, “resulting_in_”, “rnge”, “route”, “repeat_”, “sans_”, “scan_”, “sensitivity_”, “specificity_”, “specific_reason_of_”, “start_”, “stop_”, “since_”, “subsidy_”, “that_”, “though_”, “thru_”, “throughout_”, “to_”, “toward_”, “target_”, “then_”, “trademark_is_”, “to_”, “trade_name_”, “under_”, “unit_”, “unless_”, “until_”, “up_”, “unit_”, “use_with_care_in”, “use_in_”, “use_with_care_”, “via_”, “value_”, “val_”, “when_”, “whether_”, “while_”, “with_”, “within_” “was_”, “with_respect_to_”, “who_”, “why_”, “with_”, “without_” “with_consequence_of”, “yet_”

non_alphanumeric_character=>!,@,#,$,%,̂,&,*,?,/,|,\,:,;,“,‘,{,[,},],(,),−,+,=,+,<,>, . . . space

numeric_type_character=>0,1,2,3,4,5,6,7,8,9, . . . , +,−

character_uppercase=>A,B,C,D,E,F,G,H,I,J,K,L,M,N,O,P,Q,R,S,I,U,V,W,X,Y,Z

numeric_type=numeric_type_character*

alphanumeric_character_lower_cased=>a,b,c,d,e,f,g,h,i,j,k,l,m,n,o,p,q,r,s,t,u,v,w,x,y,z,0,1,2,3,4,5,6,7,8,9

character=non_alphanumeric_character, alphanumeric_character_lower_cased, character_uppercase, character_uppercase

string_literal=“″”+character*+“″”

explicit_word=>alphanumeric_character_lower_cased*

explicit_word_underscore=>explicit_word+“_”

explicit_health_code=>explicit_word_underscore_+explicit_word_underscore_*

genre_subject_segment=>genre_key+“ ”+explicit_health_code

cliched_predicate_value=>explicit_health_code, string_literal, numeric_type, parenthetical_explicit_health_programming_language_statement

key_value_cliched_predicate=>predicate_key+“ ”+cliched_predicate_value

key_value_cliched_predicatc_segment=>“,”+key_value_cliched_predicate

parenthetic_key_value_cliched_predicate_segment=>“(”+key_value_cliched_predicate+“)”

comma_delimited_explicit_health_programming_language_statement=>genre_subject_segment+key_value_cliched_predicate_segment*

parenthetical_explicit_health_programming_language_statement=>“(”+genre_subject_segment+“)”+parenthetical_key_value_cliched_predicate_segment*

Notes to Appendix:

It is possible to make explicit health programming language statements executable by mapping it to a functional language: i.e. Parenthephilia

To enable a medical record to be executed like a computer program, one has to built a computer interpreter or compiler for EHPL. The preferred embodiment is to transform the EHPL to program statements that will run on an off-the-shelf computer language environment. EHPL can be transformed into one of the functional programming languages belonging to the Lisp family. Lisp is made up of S-expressions which are easy to parse because they have a simple grammar:
expression::=atom,,(,expression*,),.

Patient files encoded in parenthephilia can be executed by a lisp interpreter.

We start with the clinical statement:

problem_fracture_femur, ctx_right_{—}

is parsed to give:

evaluation_fracture_femur_, context_right_{—}

The above statement is parsed by parenthephilia to a computable statement expressed in the functional language Lisp:

‘((ev_fracture_femur_)(ctx_right_))

The quote is to stop further processing and denotes that it is a data statement. The function ev_ stands for “clinical evaluation” and the function ctx stands for_ “context”.

Note that a EHPL statement is segmented into S-expressions and is now made into a computable functional language statement.

The Kleene Star Specification of Commatoast

Commatoast is a natural language health dialect (NLHD).

Commatoast basic structure is a natural language “sentence” that conveys a more nuanced and complex meaning than a mere concept code. For example, a clinician may want to code for diabetes mellitus with chronic renal failure and is on treatment with insulin as a collective unit (In docle that is ev:diabm,with:crf,rx:insu, which is difficult to derive, opening up the need for a NLHD).

A commatoast sentence is assembled by building up pairs of meanings. The commatoast sentence is segmented by using the mighty comma operator-producing segments.

Each segment comprises a pair. The first pairing is defined as the genre-subject segment, it has a genre key with a subject. The genre key may be of one or two or three words. Examples being 1) problems 2) past history and 3) reason for encounter.

After accounting for the genre-subject segment, there may be subsequent (zero or more) segments, these are defined as key-value-cliched-predicates.

Each key-value-cliched-predicate pairing comprises 1) an initial comma separator 2) a predicate key 3) a predicate value, which may be a medical concept, a literal or special numeric value used in clinical medicine. It will be apparent to the skilled user that Commatoast may be parsed to EHPL.

With the Kleene star notation, 0 indicates a choice of nothing at all, while a comma indicates a choice of several or more alternatives, while a * at the end of a name symbol means zero or more repetitions of the underlying name. A + at the end of a name symbol means one or more repetitions of the underlying name.

Using the Kleene star notation:

commatoast_message=>commatoast sentences, cascaded_block_commatoast*

cascaded_block_commatoast=>genre+cascaded_commatoast_statement*

colonoscoop_word=>word+“:”

macro expand (colonoscoop_word)=>“,”+word

commatoast sentence=>genre_subject_segment+key_value_cliched_predicate_segment*

commatoast sentence=>commatoast sentence, genre+“ ”+cascaded_commatoast_statement

cascaded_commatoast_statement=>(“nl”)+subject+(“ ”+)+key_value_cliched_predicate_segment*

genre_subject_segment=>genre+“ ”+subject

key_value_cliched_predicate_segment=>(“,”)+kvcp_key+(“ ”+) kvcp_value

kvcp_key=>word+((“ ”+)+(word))*

kvcp_value=>word+((“ ”+)+(word))*

The EBNF for Commatoast

The language definition of commatoast is based on Extended Backus Naur Formalism

The EBNF Syntax rules are defined as

Syntax=(rule).

rule=identifier “=” expression “.”.

expression=term {“|” term}.

term=factor {factor}.

factor=identifier|string|“(“expression”)” |“[” expression “]” |“{“expression”}”.

The Commatoast Language is a sequence of syntax rules.

The right hand of each rule defines syntax based on previous rules and terminal symbols.

Parentheses ( ) group alternate terms.

The vertical bar | separates alternate terms.

Square brackets [ ] denote optional expressions.

Braces { } denote expressions that may occur zero or more times.

A medical Expression is a generally accepted medical expression in natural language. In the examples English is used.

commatoast_segment_separator=“,” |“|”.

docleOperators=“!”|“<”|“>”|“%”|“@”|“#”|“$”|“%”|“̂”|“&”|“*”

letter=capital Letter|“a”|“b”|“c”|“d”|“e”|“f”|“g”|“h”|“i”|“j”|“k”|“l”|“m”|“n”|“o”|“p”|“q”|“r”|“s”|“t”|“u”|“v”|“w”|“x”|“y”|“z”.

capitalLetter=“A”|“B”|“C”|“D”|“E”|“F”|“G”|“H”|“I”|“J”|“K”|“L”|“M”|“N”|“O”|“P”|“Q”|“R”|“S”|“T”|“U”|“V”|“W”|“X”|“Y”|“Z”.

digit=“0”|“1”|“2”|“3”|“4”|“5”|“6”|“7”|“8”|“9”.

nextline=cr|lf|crlf.

character=letter|digit|docleOperator

word={character}.

docle_primary_key=word in docle linnean hiearchy

docle_secondary_key=docle_algorithm(docle_primary_key)

docle_tertiary_key=alias(docle_secondary_key)

docle_key=docle_primary_key|docle_secondary_key|docle_tertiary_key

medical_expression=word {“ ”word}|docle_keys.

predicate_key=“about”|“above”|“across”|“after”|“against”|“ahead of”|“along”|“although”|“among”|“and”|“around”|“as”|“ask”|“asso”|“at”|“auth”|“beos”|“behind”|“below”|“before”|“beside”|“between”|“but”|“by”|“comx”|“coda”|“esdr”|“ctx”|“date”|“dateEvent”|“dose”|“down”|“during”|“except”|“fact”|“find”|“for”|“freq”|“from”|“go”|“how”|“if”|“in”|“is”|“inFrontOf”|“insteadOf”|“into”|“ix”|“like”|“more”|“no”|“not”|“near”|“next to”|“not”|“note”|“of”|“on”|“onto”|“original”|“outx”|“over”|“pack”|“qty”|“rpt”|“sans”|“start”|“stop”|“since”|“that”|“though”|“thru”|“throughout”|“tn”|“to”|“toward”|“under”|“unit”|“unless”|“until”|“up”|“val”|“when”|“whether”|“while”|“who”|“why”|“with”|“within”|“yet”|docle_primary_key|docle_secondary_key|docle_tertiary_key|‘adecrartg’|‘adec rating’|‘adr’|‘adr to’|‘adr with’|‘adverse drug reaction from’|‘adverse drug reaction predicate key’|‘arising from’|‘as’|‘associated with’|‘association’|‘bcos’|‘bcoz’|‘because of’|‘being’|‘check’|‘consequence of’|‘consequently’|‘consider’|‘context’|‘contraindicatedcontraindication’|‘coz’|‘csdr’|‘etx’|‘do@not@use@in’|‘dosage’|‘dose’|‘dosing’|‘do not use in’|‘do not use in the event’|‘do not use in the following circumstances’|‘due@to’|‘ex’|‘extra’|‘find’|‘finding’|‘finding of’|‘fmlt’|‘for’|‘formulation’|‘for specified reason of’|‘freq’|‘frequency’|‘from’|‘future treatment’|‘goal’|‘how@many’|‘if’|‘immunization’|‘immx’|‘in’|‘indication’|‘interact’|‘interaction’|‘interacts with’|‘interact with’|‘intx’|‘in case of’|‘in the event of’|‘in the year’|‘is’|‘leading to’|‘mode@act’|‘mode action’|‘mode of action’|‘more’|‘no’|‘not to be used in’|‘on’|‘on this date’|‘outcome’|‘outx’|‘pack’|‘packaging’|‘pk’|‘plan’|‘planning’|‘plus’|‘pred@key’|‘predicate key’|‘pregnancy rating’|‘prior’|‘px’|‘qty ’|‘quantity’|‘r’|‘range’|‘rank’|‘ranking’|‘repeat’|‘resulting in’|‘rnge’|‘route’|‘rpt’|‘sans’|‘scan’|‘scns’|‘sensitivity’|‘specificity’|‘specified reason of’|‘spef’|‘ssdy’|‘subsidy’|‘target’|‘then’|‘tn’|‘tn@is’|‘to’|‘trade name’|‘unit’|‘use@in’|‘use@with@care@in’|‘use in’|‘use with care’|‘via’|‘was’|‘who’|‘with’|‘without’|‘with consequence’|‘with consequence of’|‘xtra’.

genre=“reason for encounter”|“hx”|“px”|“hxpx”|“dx”|“dx+”|“dx˜”|“dx−”|“adr”|“allg”|“kiv”|“risk”|“warn”|“phx”|“fh”|“sh”|“ix”|“outx”|“goal”|“plan”|“tx”|“no”|“admn”|“?”|“memo”|“mix”|‘active_problems’|‘administration’|‘active problems’|‘administration’|‘administration context’|‘adr genre,adverse effects genre’|‘allergy genre’|‘allg genre’|‘context administration’|‘context adverse drug reactions’|‘context denouement’|‘context drug allergies’|‘context evaluation’|‘context examination physical’|‘context family history’|‘context goal’|‘context history’|‘context history examination’|‘context immunizations’|‘context investigation’|‘context outcome’|‘context planning’|‘context social history’|‘denoucmcnt contcxt’|‘diagnosis heuristic’|‘disease heuristic’|‘drug adverse reactions context’|‘drug allergy context’|‘drug heuristic’|‘drug rule’|‘drug treatment context’|‘dx heur’|‘evaluation context’|‘examination findings’|‘examination physical context’|‘family history’|‘family story’|‘fh’|‘fbx’|‘general particulars’|‘genr’|‘genre’|‘genre allergies’|‘goals’|‘goal context’|‘heuristic diagnosis’|‘heuristic disease’|‘heuristic drug’|‘heuristic examination’|‘heuristic history’|‘heuristic hx’|‘heuristic hxpx’|‘heuristic investigation’|‘heuristic ix’|‘heuristic presentation’|‘heuristic procedures’|‘heuristic px’|‘heuristic syndrome’|‘heur dx’|‘heur hxpx’|‘heur ppoc’|‘history’|‘history context’|‘history examination context’|‘history heuristic’|‘hx’|‘hxpx heur’|‘immunisations’|‘immunizations’|‘immunizations context’|‘investigations’|‘investigation context’|‘investigation heuristic’|‘ix’|‘ix heuristic’|‘lab test heuristic’|‘medications’|‘on examination context’|‘outcomes’|‘outcome context’|‘outx context’|‘particulars’|‘past history context’|‘patient details’|‘phx section’|‘planning context’|‘plans’|‘ppoc heur’|‘presentation’|‘presentation heuristic’|‘problem’|‘problems’|‘procedure heuristic’|‘progress review context’|‘risk’|‘risks’|‘risk factor’|‘risk factors’|‘risk from’|‘rule drug’|‘sh’|‘shx’|‘social history’|‘social history context’|‘subjective’|‘syndrome heuristic’|‘tests’|‘treatment drug context’

subject=docle_key.

predicate_key=docle_key

predicate_value=docle_key|literal_value

predicate=[predicate_key] predicate_value

cascaded statement=genre|subject {segment_separator predicate}

statement=caseaded_statement|genre subject,{commatoast_segment_separator predicate}.

compoundStatement=statement {nextline statement}.

Kleene Star Representation of Compositional Docle

Compositional docle is defined as the post coordinated version of the docle coding system. It is a potential target for further parsing of EHPL.

Whereas the docle coding system comprises codes for medical concepts, compositional docle codes assemble the docle codes into “sentences” that convey a more nuanced and complex meaning.

A compositional docle code is assembled by building up pairs. The first pairing is of a docle code genre key with a docle code subject with an infix operator “:” to separate the genre key from the subject.

This is followed by zero or more predicate pairings comprising 1) an initial comma separator 2), a docle predicate key, 3) an infix operator “:” to separate the predicate key from the predicate value, 4) the predicate value which may be a docle code, a literal or special numeric value.

Using the Kleene star notation:

compositional_docle=>genre_key+“:”+subject+kvcp*

kvcp=>“,”+predicatc_key+“:”+predicate_value

predicate_value=>docle_code, literal_value, e_health_values

The EBNF Syntax definition for compositional docle health coding is defined below:

Syntax={rule}.

rule=identifier “=” expression “.”.

expression=term {“|” term}.

term=factor {factor}.

factor=identifier|string|“(“expression”)”|“[“expression”]”|“{“expression”}”.

The compositional docle code is a sequence of syntax rules.

The right hand of each rule defines syntax based on previous rules and terminal symbols.

Parentheses ( ) group alternate terms.

The vertical bar | separates alternate terms.

Square brackets [ ] denote optional expressions.

Braces { } denote expressions that may occur zero or more times.

A medicalExpression is a generally accepted medical expression in natural language. In the examples English is used.

docleOperators=“!”|“<”|“>”|“%”|“@”|“#”|“$”|“%”|“̂”|“&”|“*”

letter=capital Letter|“a”|“b”|“c”|“d”|“e”|“f”|“g”|“h”|“i”|“j”|“k”|“l”|“m”|“n”|“o”|“p”|“q”|“r”|“s”|“t”|“u”|“v”|“w”|“x”|“y”|“z”.

capitalLetter=“A”|“B”|“C”|“D”|“E”|“F”|“G”|“H”|“I”|“J”|“K”|“L”|“M”|“N”|“O”|“P”|“Q”|“R”|“S”|“T”|“U”|“V”|“W”|“X”|“Y”|“Z”.

digit=“0”|“1”|“2”|“3”|“4”|“5”|“6”|“7”|“8”|“9”.

nextline=cr|lf|crlf.

character=letter|digit|docleOperator

word={character}.

docle=word in docle linnean hiearchy

doclepredicate_key=word with genus of “predrakeŷ”

docle_genre_key=word with genus of “genrê”

docle_predicate_key=“about”|“above”|“across”|“after”|“against”|“ahead of”|“along”|“although”|“among”|“and”|“around”|“as”|“ask”|“asso”|“at”|“auth”|“bcos”|“behind”|“below”|“before”|“beside”|“between”|“but”|“by”|“comx”|“coda”|“csdr”|“ctx”|“date”|“dateEvent”|“dose”|“down”|“during”|“except”|“fact”|“find”|“for”|“freq”|“from”|“go”|“how”|“if”|“in”|“is”|“inFrontOf”|“insteadOf”|“into”|“ix”|“like”|“more”|“no”|“not”|“near”|“next to”|“not”|“note”|“of”|“on”|“onto”|“original”|“outx”|“over”|“pack”|“qty”|“rpt”|“sans”|“start”|“stop”|“since”|“that”|“though”|“thru”|“throughout”|“tn”|“to”|“toward”|“under”|“unit”|“unless”|“until”|“up”|“val”|“when”|“whether”|“while”|“who”|“why”|“with”|“within”|“yet”|docle_primary_key|docle_secondary_key|docle_tertiary_key|‘adec@rtg’|‘adec rating’|‘adr’|‘adr to’|‘adr with’|‘adverse drug reaction from’|‘adverse drug reaction predicate key’|‘arising from’|‘as’|‘associated with’|‘association’|‘bcos’|‘bcoz’|‘because of’|‘being’|‘check’|‘consequence of’|‘consequently’|‘consider’|‘context’|‘contraindicated’|‘contraindication’|‘coz’|‘csdr’|‘ctx’|‘doranot@use@in’|‘dosage’|‘dose’|‘dosing’|‘do not use in’|‘do not use in the event’|‘do not use in the following circumstances’|‘due@to’|‘ex’|‘extra’|‘find’|‘finding’|‘finding of’|‘fmlt’|‘for’|‘formulation’|‘for specified reason of’|‘freq’|‘frequency’|‘from’|‘future treatment’|‘goal’|‘if’|‘immunization’|‘immx’|‘in’|‘indication’|‘interact’|‘interaction’|‘interacts with’|‘interact with’|‘intx’|‘in case of’|‘in the event of’|‘in the year’|‘is’|‘leading to’|‘mode@act’|‘mode action’|‘mode of action’|‘more’|‘no’|‘not to be used in’|‘on’|‘on this date’|‘outcome’|‘outx’|‘pack’|‘packaging’|‘pk’|‘plan’|‘planning’|‘plus’|‘predigkey’|‘predicate key’|‘pregnancy rating’|‘prior’|‘px’|‘qty’|‘quantity’|‘r’|‘range’|‘rank’|‘ranking’|‘repeat’|‘resulting in’|‘rnge’|‘route’|‘rpt’|‘sans’|‘scan’|‘sens’|‘sensitivity’|‘specificity’|‘specified reason of’|‘spof’|‘ssdy’|‘subsidy’|‘target’|‘then’|‘tn’|‘tn@is’|‘to’|‘trade name’|‘unit’|‘use@in’|‘use@with@care@in’|‘use in’|‘use with care’|‘via’|‘was’|‘who’|‘with’|‘without’|‘with consequence’|‘with consequence of’|‘xtra’.

genre=“reason for encounter”|“hx”|“px”|“hxpx”|“dx”|“dx+”|“dx˜”|“dx−”|“adr”|“allg”|“kiv”|“risk”|“warn”|“phx”|“fh”|“sh”|“ix”|“outx”|“goal”|“plan”|“tx”|“no”|“admn”|“?”|“memo”|“mix”|‘active_problems’|‘administration’|‘active problems’|‘administration’|‘administration context’|‘adr genre,adverse effects genre’|‘allergy genre’|‘allg genre’|‘context administration’|‘context adverse drug reactions’|‘context denouement’|‘context drug allergies’|‘context evaluation’|‘context examination physical’|‘context family history’|‘context goal’|‘context history’|‘context history examination’|‘context immunizations’|‘context investigation’|‘context outcome’|‘context planning’|‘context social history’|‘denouement context’|‘diagnosis heuristic’|‘disease heuristic’|‘drug adverse reactions context’|‘drug allergy context’|‘drug heuristic’|‘drug rule’|‘drug treatment context’|‘dx heur’|‘evaluation context’|‘examination findings’|‘examination physical context’|‘family history’|‘family story’|‘fh’|‘fhx’|‘general particulars’|‘genr’|‘genre’|‘genre allergies’|‘goals’|‘goal context’|‘heuristic diagnosis’|‘heuristic disease’|‘heuristic drug’|‘heuristic examination’|‘heuristic history’|‘heuristic hx’|‘heuristic hxpx’|‘heuristic investigation’|‘heuristic ix’|‘heuristic presentation’|‘heuristic procedures’|‘heuristic px’|‘heuristic syndrome’|‘heur dx’|‘heur hxpx’|‘heur ppoc’|‘history’|‘history context’|‘history examination context’|‘history heuristic’|‘hx’|‘hxpx heur’|‘immunisations’|‘immunizations’|‘immunizations context’|‘investigations’|‘investigation context’|‘investigation heuristic’|‘ix’|‘ix heuristic’|‘lab test heuristic’|‘medications’|‘on examination context’|‘outcomes’|‘outcome context’|‘outx context’|‘particulars’|‘past history context’|‘patient details’|‘phx section’|‘planning context’|‘plans’|‘ppoc heur’|‘presentation’|‘presentation heuristic’|‘problem’|‘problems’|‘procedure heuristic’|‘progress review context’|‘risk’|‘risks’|‘risk factor’|‘risk factors’|‘risk from’|‘rule drug’|‘sh’|‘shx’|‘social history’|‘social history context’|‘subjective’|‘syndrome heuristic’|‘tests’|‘treatment drug context’

genre_subject=docle_genre_key:subject

subject=docle_key

predicate_key=doele_key

predicate value=docle_key|literal_value

predicate=, predicate_key:predicate value

compositional_docle=genre_subject{predicate}

1. A method for implementing a medical informatics system, the method comprising the step of creating one or more named medical objects having attributes and behaviours, each object being implemented as an object in an object oriented programming paradigm, a function in a functional programming paradigm or an equivalent entity in a hybrid functional/object oriented programming paradigm, wherein the or each medical object name is derived from an algorithmic transformation of a description key assigned to a corresponding medical concept in a medical coding or classification system into an explicit health code, the named medical object having the attributes and behaviours of the corresponding medical concept, the composition of explicit health codes and medical objects derived therefrom being suitable for computer representation of medical narratives.

2. A method according to claim 1 wherein the algorithmic transformation involves applying a naming algorithm to a description key whereby the description key is modified to conform to an object-naming, function-naming or entity-naming methodology applicable to the objected-oriented, functional or hybrid programming paradigm.

3. A method according to claim 2, wherein the naming algorithm comprises the steps of:
(a) stripping leading or trailing non-alphanumeric characters from the description key;
(b) replacing remaining non-alphanumeric characters with a delimiter character;
(c) deleting any multiple occurrences of the delimiter character; and
(d) appending or prepending a delimiter character to thereby stigmatize the medical object name from computer keywords and ubiquitous health language.

4. A method according to claim 3, wherein the naming algorithm comprises the further step of converting the description key to all lowercase characters or all uppercase characters after performing the stripping step.

5. A method according to claims 3, wherein the replacing step comprises the step of camel casing the first character of each word of the description key.

6. A method according to claim 3, further comprising the step of permuting the words of the description key prior to the replacing step thereby enabling derivation of multiple medical object names from a single description key.

7. A method according to claim 3, wherein the delimiter character is an underscore character.

8. A method according to claim 1, wherein the medical coding or classification system is a non-numeric medical classification system.

9. A method according to claim 1, wherein the medical coding or classification system is a compositional medical classification system.

10. A method according to claim 1, wherein the medical coding or classification system is a compositional and hierarchical medical classification system and wherein the medical objects implement a corresponding object or functional hierarchy.

11. A method according to claim 1, wherein the medical coding or classification system is predicate on terminology of explicit health codes for its canonical codes and descriptions.

12. A method according to claim 1, wherein the step of creating a named medical object comprises:
(a) causing the derived medical object name to raise an error condition within a root object of an object hierarchy of the object oriented programming paradigm;
(b) confirming that the error condition was created by a symbolic representation of the derived medical object name; and
(c) creating the virtual medical object by searching a lookup table or database using the symbolic representation as a search key to obtain object attribute and behaviours.

13. A method according to claim 1, further including the step of creating a plurality of medical object statements, each statement comprising one or more medical object segments, with each segment comprising a pair of medical objects.

14. A method according to claim 13, wherein the medical object statement includes a head segment and zero or more follower segments, the head segment including a genre medical object and a subject medical object, the or each follower segments including a pair of predicate medical objects.

15. A method according to claim 14, wherein the genre medical object is implemented as a function in a functional programming paradigm and the subject medical object and predicate medical objects are implemented as either string or symbol arguments for the function.

16. A method according to claim 1, wherein the description key is a diagnosis, medication, radiology investigation, lab test, test result, medical procedure, item of patient data, medical statement, medical heuristic, set of medical heuristics, medical message, medical summary, fragment of medical summary, patient history or fragment of patient history.

17. A method according to claim 1, further including the step of creating a messaging system for sending messages to and receiving information from the named medical objects.

18. A method according to claim 17, wherein, responsive to receipt of a message, a named medical object acts in accordance with a stored behaviour.

19. A method according to claim 18, wherein an action in accordance with a stored behaviour characteristic includes one or more of: issuing a notification of a preventative health action, issuing an alert, sending an email, printing a file, sending an sms message, telephoning a stored telephone number, opening a computer port or communication channel to receive a service query.

20. A computer program implementing a medical decision support system, the medical decision support system based on data generated by performing the method according to claim 1.

21. A computerised medical record system comprising a plurality of medical records, wherein each medical record is generated by performing the method according to claim 1.

22. A medical informatics system comprising:
(a) a data file containing a medical record coded in accordance with a medical classification system; and
(b) a computer processor for performing the method according to any one of claim 1,
wherein upon performance of the method by the processor, the data file is opened and suitable named medical objects created from the data in the data file.

23. A method for implementing a medical informatics system based on a computer executable health narrative coding system, the method comprising the steps of:
(a) generating a single uniform vocabulary for a given health concept coding or classification system based on an algorithmic transformation of each natural language description of each health concept code to derive an explicit health code, wherein each explicit health code conforms to the naming convention used in object oriented/functional/hybrid programming languages and when an explicit health code is presented as a bare word to the programming environment it is evaluated to be a first class programmable medical object in an object oriented programming paradigm or as a function in a functional programming paradigm, having attributes and behaviours of its source medical classification system, the composition of explicit health codes forming statements for coding health narratives;
(b) evaluating the explicit health codes into programmable medical objects and/or functions; and
(c) executing the programmable medical objects and/or functions to effect decision support.

24. A method of augmenting an extant health concept coding system by transformation into a uniform narrative health coding system employing a compositional and computer-executable explicit health language, the method comprising the steps of:
(a) defining a syntax of explicit health codes that do not conflict with language definition of a host programming language;
(b) defining a syntax and grammar of explicit health programming language (EHPL) based on compositions of explicit health codes, the EHPL not conflicting with language definition of the host programming language;
(c) mapping extant health concept codes (e.g. docle, snomed) to explicit health codes;
(d) assembling EPHL statements with character delimited patterns of pairs, with an initial pair of genre-subject, followed by zero or more pairs of key-value cliched predicates;
(e) integrating the EPHL statements in a programming language runtime;
(f) integrating extant health concept coding runtime and belief system;
(g) executing any such EHPL codes or statements in a tripartite runtime environment of EHPL, host programming language and resident health concept coding and belief system, with each explicit health code being transformed into full fledged computer programmable objects, wherein said objects provide:
(i) a means for an extant health concept coding system to code for a narrative;
(ii) interoperable health based on exchanges of this EHPL statements (or their precursors) used for computer representation of patient data, patient medical record, medical decision tasks, medical heuristics and medical messaging;
(iii) enhanced decision support, as statements in EHPL such as a medical summary can be parsed and run as a computer process in the tripartite environment; and
(iv) enhanced decision support as each explicit code is a first class computer medical object in the programmatic environment and able to listen and respond to messages from other medical objects.
